(19) United States
(12) Patent Application Publication
(10) Pub. No.: US 2026/0217461 A1
(43) Pub. Date: Jul. 30, 2026

(54) UNIT STORAGE SYSTEM

(71) Applicant: Justin William Allen JAMES, New South Wales (AU)

(72) Inventor: Justin William Allen JAMES, New South Wales (AU)

(21) Appl. No.: 19/147,286

(22) PCT Filed: Jan. 11, 2024
(86) PCT No.: PCT/AU2024/050014

§ 371 Date: Jul. 10, 2025

(30) Foreign Application Priority Data
Jan. 11, 2023 (AU) 2023900055

(51) Int. Cl. B65G 1/137; B63C 15/00; B65G 1/04; B66C 17/00; E04H 6/42

(52) U.S. Cl. CPC B65G 1/1371; B65G 1/0464; B66C 17/00; B63C 15/00; E04H 6/424

(57) ABSTRACT

A unit storage facility and associated method. The facility comprises a plurality of displaceable and releasably connectable structures, each structure being configured to support at least one unit. The facility further comprises a crane having a supporting structure and a crane body displaceably connected to the supporting structure. The crane body comprises a lifting member, the lifting member being operable to displace and releasably connect or disconnect one or more structures of the plurality of structures.

### TECHNICAL FIELD

The present disclosure relates, generally, to a unit storage system.

### BACKGROUND

It is desirable for unit storage facilities to maximise the use of space. For example, storage facilities for racking units such as domestic or commercial storage or for vehicles, including automobiles or vessels, generally include a pathway, usually along the centre of the facility, to allow passage for humans and/or vehicles such as rubber tyred gantry cranes (RTGs), elevating transfer vehicles (ETVs) or forklifts (FLTs) in order to store and retrieve the racked units. Units and other items cannot be stored on such pathways as this would inhibit movement through the facility and would present safety concerns such as RTGs, ETVs or FLTs or units colliding with other units, other items or facility personnel. It is also desirable to reduce the prevalence of facility personnel injuries and to improve the speed at which units are stored and accessed in unit storage facilities.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In an aspect of the present disclosure, there is provided a unit storage facility, comprising: a plurality of displaceable and releasably connectable structures, each structure being configured to support at least one unit (e.g. a vehicle such as an automobile or a vessel, or stock for a store, or collectables); and a crane having a supporting structure and a crane body displaceably connected to the supporting structure, the crane body comprising a lifting member, the lifting member being operable to displace and releasably connect or disconnect one or more structures of the plurality of structures.

The structures may be connectable, and when connected, form at least one stack, and the crane may be operable to retrieve one or more target structures from the at least one stack. The, or each, stack may comprise layers of structures. At least one layer in the stack may be oriented in a different direction to at least one of its adjacent layers. The layers may be arranged in alternating orientations. Each layer may be oriented at or approximately 90 degrees to its adjacent layers. One or more of the plurality of structures may have a different size to others of the plurality of structures. The plurality of structures may comprise one or more structures of a first, smaller size and one or more structures of a second, relatively larger size. The structures of the first size may be connected to form at least a first layer in the stack, and the structures of the second size may be connected to form at least a second layer in the stack, or the structures of the first size may be connected to form a first stack, and the structures of the second size may be connected to form a second stack. The plurality of structures may each be of the same size.

Each structure may comprise: a frame defining a first side and an opposed, second side, one or more elongate supports fixed to the frame for supporting the stored at least one unit, a plurality of receptacles defined in the second side of the frame, and a plurality of connectors disposed on the first side of the frame, each connector being receivable in a receptacle of another structure. A set of structures may be connectable by the lifting member placing one or more of the set of structures in a first orientation on top of a layer of one or more of the set of structures in a second orientation, such that one or more of the connectors of the, or each, structure in the second orientation are received in respective receptacles of the, or each, structure in the first orientation.

Each structure may comprise a sloped covering within the frame disposed at the first side of the structure.

The unit storage facility may further comprise a controller for operating the lifting member of the crane, the controller comprising a processing module configured to determine a set of moves for the lifting member and a memory module in communication with the processing module, the processing module being configured to: store a location of each structure in the stack to the memory module, analyse the locations of the structures in the stack to determine a set of structures to be displaced for accessing the one or more target structures, and determine the set of moves to be performed by the lifting member, each move corresponding to one of the set of structures being displaced.

Each structure may comprise at least one sensor in communication with the controller to provide structure location data to the processing module for storing in the memory module. The set of structures to be displaced may be determined to allow the one or more target structures to be positioned in a relatively accessible location. The processing module may be configured to minimise a total number of moves in the set of moves.

Each structure may comprise one or any combination of operational modules comprising: an air conditioner; a dehumidifier; a thermometer; an optical sensor, by example a camera, preferably a closed circuit television camera; a Global Positioning System (GPS) module; a renewable energy generation module, such as comprising one or more solar panels; and an energy storage module, such as comprising one or more batteries and an inverter.

The operational module or operational modules may be in data communication with the processing module, the processing module being configured to transmit and/or receive operational data to and/or from the operational module or operational modules. The processing module may be configured to transmit and/or receive the operational data to and/or from a remote facility and/or a remote computing device. The remote computing device may be a smart device in network connection with the processing module and/or the remote facility. The remote facility may be a cloud computing facility.

Each structure may comprise thermal insulation.

The controller may further comprise a transmitting module in communication with the processing module for transmitting instructions to the lifting member. The transmitting module may be configured to transmit the set of moves as instructions to the lifting member to perform the set of moves. The controller may further comprise a selection module in communication with the processing module, the selection module being operable by a user to select one or more stored units to be retrieved by the lifting member, each of the selected units corresponding to a target structure. The selection module may comprise a booking system for enabling a user to book a collection time for the one or more stored units, the transmitting module being configured to transmit the set of moves to the lifting member at a predetermined time such that the selected units are accessible by the user at the collection time.

The unit storage facility may further comprise an enclosure surrounding the plurality of structures and the crane.

In another aspect of the present disclosure there is provided a unit storage facility, comprising:
a plurality of displaceable and releasably connectable structures, each structure being configured to support at least one unit and comprising a frame defining a first side and an opposed second side, a plurality of receptacles defined in the second side of the frame and a plurality of connectors disposed on the first side of the frame, a connector being receivable in a receptacle of another structure and configured to allow each structure to releasably connect with another structure and to allow the plurality of structures to be stacked in adjacent layers oriented in different directions to form at least one stack; and
a crane having a supporting structure and a crane body displaceably connected to the supporting structure, the crane body comprising a lifting member, the lifting member being operable to displace and releasably connect or disconnect one or more structures of the plurality of structures in the at least one stack.

In another aspect of the present disclosure, there is provided a structure for use in the unit storage facility described above.

In another aspect of the present disclosure, there is provided a unit storage method, comprising: storing at least one unit in each of a plurality of displaceable and releasably connectable structures, each structure being configured to support the at least one unit; and operating a crane to displace and releasably connect or disconnect one or more structures of the plurality of structures, the crane having a supporting structure and a crane body displaceably connected to the supporting structure, the crane body comprising a lifting member, the lifting member being operable to displace and releasably connect or disconnect the one or more structures of the plurality of structures.

The operating the crane may comprise retrieving one or more target structures of the plurality of structures. The operating the crane may further comprise connecting the structures to form at least one stack, and the retrieving the one or more target structures may comprise retrieving the one or more target structures from the at least one stack. The, or each, stack may comprise layers of structures, and the operating the crane may further comprise arranging the layers in alternating orientations.

Each structure may comprise: a frame defining a first side and an opposed, second side, one or more elongate supports fixed to the frame for supporting the stored at least one unit, a plurality of receptacles defined in the second side of the frame, and a plurality of connectors disposed on the first side of the frame, each connector being receivable in a receptacle of another structure, and the arranging the layers in alternating orientations may comprise the lifting member placing one or more of a set of structures in a first orientation on top of a layer of one or more of the set of structures in a second orientation, such that one or more of the connectors of the, or each, structure in the second orientation are received in respective receptacles of the, or each, structure in the first orientation, thereby connecting the set of structures.

The operating the crane may further comprise using a controller for operating the lifting member of the crane, the controller comprising a processing module configured to determine a set of moves for the lifting member and a memory module in communication with the processing module, the processing module being configured to: store a location of each structure in the stack to the memory module, analyse the locations of the structures in the stack to determine a set of structures to be displaced for accessing the one or more target structures, and determine the set of moves to be performed by the lifting member, each move corresponding to one of the set of structures being displaced.

The controller may further comprise a transmitting module for transmitting instructions to the lifting member, and the operating the crane may comprise performing the set of moves using the lifting member, the set of moves being transmitted to the lifting member via the transmitting module. The performing the set of moves may comprise displacing the set of structures to allow the target structures to be positioned in a relatively accessible location. The controller may further comprise a selection module in communication with the processing module, and the method may further comprise selecting one or more stored units to be retrieved by the lifting member using the selection module, each of the selected units corresponding to a target structure.

In another aspect of the present disclosure, there is provided a unit storage method, comprising:
storing at least one unit in each of a plurality of displaceable and releasably connectable structures, each structure being configured to support the at least one unit and comprising a frame defining a first side and an opposed second side, a plurality of receptacles defined in the second side of the frame and a plurality of connectors disposed on the first side of the frame, a connector being receivable in a receptacle of another structure and configured to allow each structure to releasably connect with another structure and to allow the plurality of structures to be stacked in adjacent layers oriented in different directions to form at least one stack; and
operating a crane to displace and releasably connect or disconnect one or more structures of the plurality of structures in the at least one stack, the crane having a supporting structure and a crane body displaceably connected to the supporting structure, the crane body comprising a lifting member, the lifting member being operable to displace and releasably connect or disconnect the one or more structures of the plurality of structures in the at least one stack.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure will now be described by way of example only with reference to the accompanying drawings in which:

FIG. 1 shows a perspective view of an embodiment of a unit storage facility comprising a plurality of structures;

FIG. 2 shows a perspective view of a schematic of an embodiment of a structure of the plurality of structures shown in FIG. 1, with a plurality of connectors;

FIG. 3 shows a perspective view of a further example embodiment of a structure of the plurality of structures shown in FIG. 1, the structure comprising a cover;

FIG. 4 shows perspective views of (a) a further example embodiment of a structure of the plurality of structures shown in FIG. 1 and (b) the structure of (a) stacked together with a plurality of similar structures;

FIG. 5 shows a schematic of components of a controller of the unit storage facility shown in FIG. 1;

FIG. 6 shows a flowchart of the actions of the controller shown in FIG. 4;

FIG. 7 shows an embodiment of a unit storage method; and

FIG. 8 shows another embodiment of a unit storage method.

### DESCRIPTION OF EMBODIMENTS

In the drawings, reference numeral 10 generally designates an embodiment of a unit storage facility in the form of a vehicle storage facility, and, more particularly, in the form of a vessel storage facility 10. The facility 10 comprises a plurality of displaceable and releasably connectable structures 12, each structure 12 being configured to support at least one unit in the form of a vehicle, and, more particularly, in the form of a vessel 14a and an automobile 14b. The facility 10 further comprises a crane, in the form of a gantry crane 16, having a supporting structure 18 and a crane body 20 displaceably connected to the supporting structure 18. The crane body 20 comprises a lifting member 22, the lifting member 22 being operable to displace and releasably connect or disconnect one or more structures 12 of the plurality of structures 12. While a facility for storing vessels and/or automobiles is depicted, it will be understood that the units 14a, 14b may be any item, such as stock for a store or collectables.

In this embodiment, the supporting structure 18 is in the form of a U-shaped gantry comprising a set of vertical supports 24 secured to a base 26 of the facility 10 and comprising a set of rails 28 connected to the set of vertical supports 24 to suspend the set of rails 28 above the structures 12. The base 26 may be formed from metal, concrete, tiles, or any other suitable flooring material, and the vertical supports 24 may be secured to the base 26 by being formed within the base 26 or via the use of fasteners such as bolts, and the like. Alternatively, the facility may not include the base 26 and the vertical supports 24 may instead be secured directly into the ground.

The crane body 20 is connected to the rails 28 to allow for movement of the crane body 20 along the rails 28 in order for the lifting member 22 to move or displace the structures 12 to different positions within the facility 10. The facility 10 also comprises an enclosure 30 surrounding the plurality of structures 12 and the crane 16 in order to protect the structures 12 and the crane 16 from the elements. Again, it will be understood that the facility 10 does not require the enclosure 30.

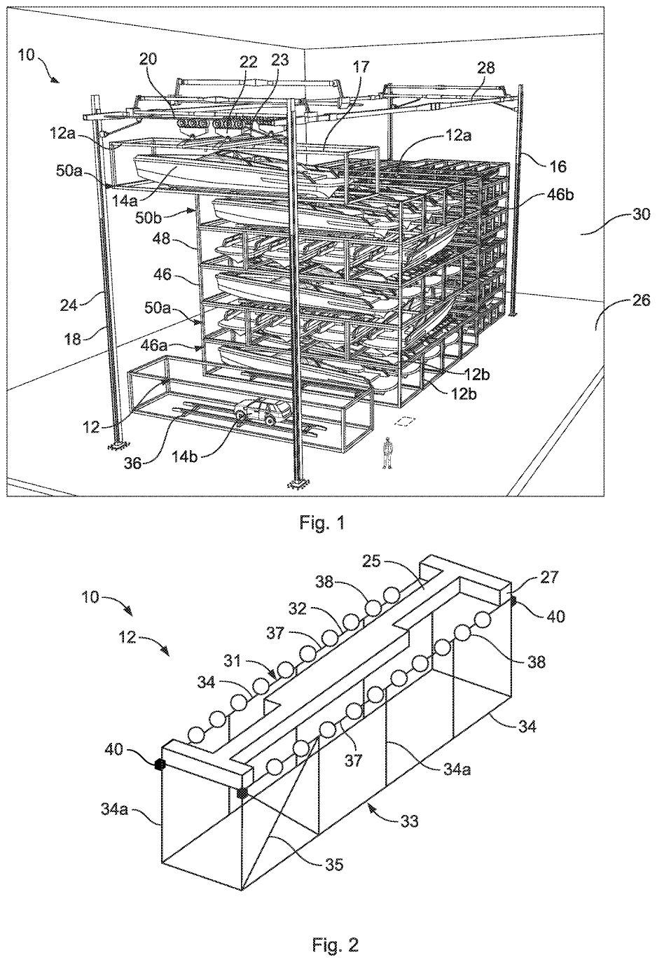

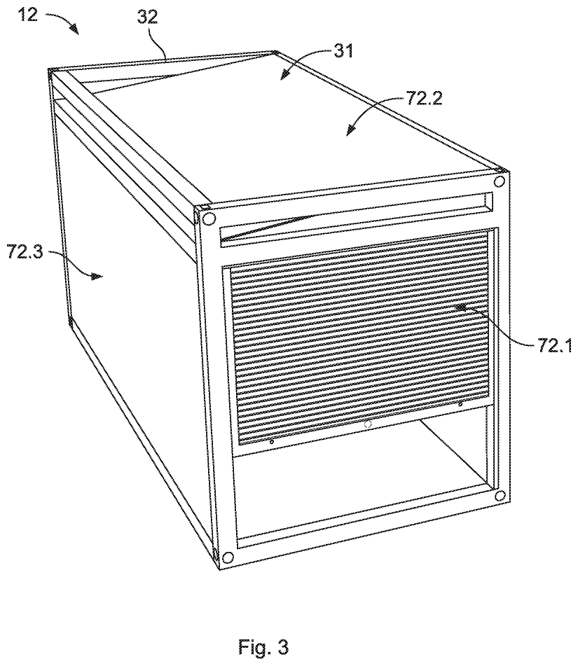

In the embodiment shown in FIG. 1, the lifting member 22 comprises a gripper, specifically a spreader 23, which is attachable to each structure 12 in a transverse direction via a set of receiving formations (not shown), for example hooks which may be configured to receive a frame member 34 of the structure 12 in order for the lifting member 22 to lift, displace, connect and/or disconnect the structure 12. Another embodiment of a spreader 25 is shown in FIG. 2, which extends in a longitudinal direction of the structure 12 and which is attachable to each corner 27 of the structure 12, for example, via a twistlock mechanism (not shown) in an embodiment whereby the structures 12 each comprise a corner casting (not shown) for the application of a twistlock mechanism.

It will be understood that the lifting member 22 may comprise more than one spreader 23, 25, for example two, three or four spreaders, each spreader being configured to carry one structure 12 in order for the lifting member 22 to displace, connect or disconnect more than one structure 12 in the same motion. Alternatively or additionally, it will be understood that a single spreader 23, 25 may be operable to displace, connect or disconnect more than one structure 12 in the same motion via, for example, an adjacent, releasable connection between the structures 12. It will also be understood by the person skilled in the art that the lifting member 22 may comprise rope or chains wound around a plurality of drums (not shown) connected to the, or each, spreader 23, 25. During lifting, each drum is able to apply an independent torque to prevent tilting of the structure 12 to counteract any displacement of a centre of gravity of the structure 12 due to the positioning and centre of gravity of the unit 14a, 14b on the structure 12.

In the embodiment shown in FIG. 2, each structure 12 comprises a frame 32 defining a first side 31 and an opposed, second side 33. The frame 32 has a plurality of connected frame members 34 to define the rectangular prism or box shape of the frame 32. The frame 32 comprises vertical frame members 34a extending between the first side 31 and the second side 33 to provide further structural strength to the structure 12, though it will be understood that these vertical frame members 34a may be omitted. One or more cross beam members 35 are also provided which extend between pairs of the vertical frame members 34a and between the first side 31 and the second side 33, though it will be understood that the one or more cross beam members 35 may be omitted. Each structure 12 also comprises one or more elongate supports 36 fixed to the frame 32 for supporting the stored at least one unit 14a, 14b. Note the supports 36 are removed from FIG. 2 for clarity.

The structure 12 comprises a plurality of connectors 38 disposed on the first side 31 of the frame 32 and a plurality of receptacles (not shown) defined in the second side 33 of the frame 32. Each connector 38 is receivable in a receptacle of another structure 12, thereby allowing the connector 38 of one structure 12 to cooperate or connect to or engage with a receptacle of another structure 12. The connectors 38 are disposed on the first side 31 in order for point loads applied to each connector 38 by one or more structures 12 placed on top of the structure 12 to be supported by the vertical frame members 34a, thereby inhibiting buckling of the frame members 34 of the frame 32. It will also be understood that some or all of the connectors 38 may alternatively be disposed on the first side 31 such that they are in register with the vertical frame members 34a. It will be understood that in the embodiment of the structure 12 including the connectors 38 and corresponding receptacles, the ability for the lifting member 22 to displace and releasably connect or disconnect the structures 12 is provided by the connectors 38 and corresponding receptacles.

In FIG. 2, the connectors 38 are substantially spherical and, when received in the receptacle, form a ball-and-socket type connection. Referring to an example embodiment of a structure 12 shown in FIG. 3, having similar features as described with reference to FIG. 2 (select features omitted from FIG. 3 for ease of understanding), it will firstly be appreciated that the frame 32 may have any shape. The structure 12 is shown to comprise a cover 72 to protect the vehicles 14a, 14b from damaging each other, for example, via leaks or unsecured items on the vehicles 14a, 14b. By non-limiting example, the cover 72 cab comprise an access 72.1, such as a roller door, a sloped covering 72.2 within the frame 32 and disposed at the first side 31 of the structure 12 and side covering 72.3. Further to the above, and by providing a sloped covering 72.2 within the frame 32 at the first side 31 as shown in FIG. 3, the structure 12 may mitigate against the accumulation of debris and moisture on top of the structure 12, by example where the facility 10 does not comprise an enclosure 30, whilst still allowing the structure 12 to be stacked with further structures 12 as further described herein. It will be appreciated that the cover 72 may be connectable to the frame 32 in various ways, by example the side covering 72.3 may be slidably connectable to the frame 32.

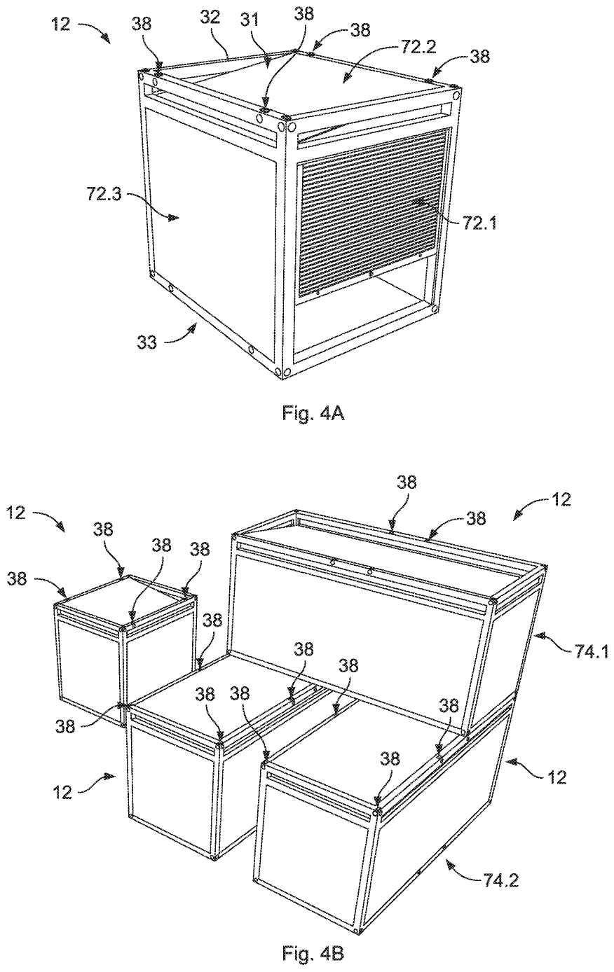

It will be understood by a person skilled in the art that the connectors 38 need not be substantially spherical as shown in FIG. 2 and may be any other shape, by non-limiting example substantially cylindrical or prism-shaped, such as a cube or a rectangular block, and that the receptacles can be correspondingly shaped to receive these alternate shaped connectors 38. In this regard, FIG. 4(a) shows an example embodiment of a structure 12 comprising a frame 32 having a box shape. The structure 12 comprises a plurality of substantially prism-shaped connectors 38 disposed on the first side 31 of the frame 32 and a plurality of receptacles (not shown) defined in the second side 33 of the frame 32. Consequently, and as shown in FIG. 4(b), the connectors 38 and corresponding receptacles of the structure 12 can be appropriately positioned along the first side 31 and second side 33 respectively such that a connector 38 of one structure 12 can cooperate or connect to or engage with a receptacle of another structure 12, including structures 12 having different frames 32 as shown for box and rectangular prism shaped structures in FIG. 4(b), so as to allow the structures 12 to be stacked in adjacent layers 74.1 and 74.2 oriented in different directions to form a stack.

The structure 12 may be between 1 m and 20 m long and typically between 6 m and 15 m long. The structure 12 shown in FIG. 2 is represented as 12 m long and the vertical frame members 34a are provided at approximately 3 m intervals along the length of the structure 12 (not to scale). As such, it can be envisaged that the depicted structure 12 is formed of essentially four 3 m cubes. The connectors 38 are disposed on, and arranged along, the frame members 34 of both edges 37 forming the first side 31 of the frame 32. In the embodiment shown in FIG. 2, the connectors 38 are arranged at 0.5 m, 1.5 m, 2.5 m, 3.5 m, 4.5 m, and so forth intervals from the nearest corner 27 of the frame 32, with the final connector 38 being arranged at the 11.5 m interval. It is noted that the spreader 25 is obstructing the view of the first and last connectors 38 (0.5 m and 11.5 m) on both edges 37 of the first side 31. This arrangement of connectors 38 allows for structures 12 of different sizes to be stacked on top of the structure 12, and also allows for structures 12 of the same size to be stacked on top of the structure 12 side-by-side or adjacently. It will be understood that more or less total connectors 38 may be provided than the total shown in FIG. 2 and that any suitable interval distance may be provided. Though the connector 38 arrangement along both edges 37 are mirror images of each other, it will be understood that a different arrangement of connectors 38 may be provided on each edge 37.

The structure 12 also comprises at least one sensor 40 connected to the corners 27 of the frame 32 and configured to determine and transmit structure location data. It will be understood that the structure 12 may instead be provided with any other suitable locating means, such as RFID tags attached to each structure 12, with the facility 10 comprising an RFID reader configured to read the RFID tags, or a Bluetooth transmitter attached to each structure 12, with the facility 10 comprising a Bluetooth receiver configured to receive Bluetooth signals from the Bluetooth transmitters. It will also be understood that the locating means may allow for all of the locations of all of the structures 12 to be analysed 60 at the same time or simultaneously by the controller 52 storing the locations of all of the structures 12 transiently or semi-permanently in the memory module 56 upon each use or application of the controller 52. It will also be understood that the locating means may allow for the locations of the structures 12 to be analysed 60 iteratively as each location of each structure 12 is added or removed from the memory module 56 permanently. It will also be understood that the structure 12 may be provided without any locating means.

The structures 12 are connected, via the connectors 38 and the receptacles of the respective structures 12, to form at least one stack 46, as shown in FIG. 1 with two stacks 46a, 46b being formed. FIG. 1 shows the structures 12 connected to form the first stack 46a having a different size to the structures 12 connected to form the second stack 46b, whereby the structures 12 of the stack 46a are of a first, larger size and the structures 12 of the stack 46b are of a second, relatively smaller size. It will be appreciated that the structures 12 could each be of the same size.

The crane 16 is operable to retrieve one or more target structures 12b from the stack 46, the target structures 12b being structures 12 which are desired to be accessed by a user. As depicted, a stack can comprise 8 layers 48, although other stack sizes can be readily envisaged. In the embodiment shown in FIG. 1, each stack 46a, 46b comprises layers 48 of structures 12, whereby at least one layer 48 in the stack 46 is oriented in a different direction to at least one of its adjacent layers 48, and, more particularly, the layers 48 are arranged in alternating orientations 50a, 50b. Each layer is oriented at or approximately 90 degrees relative to its adjacent layers 48 in order to allow for greater structural integrity of the stack 46 compared to an embodiment whereby the layers 48 are all oriented in the same manner. It will be understood that the structures 12 of the first size may alternatively be connected to form at least a first layer 48 in the stack 46, and the structures 12 of the second size may be connected to form at least a second layer 48 in the stack 46.

When adding structures to a top 17 of the stack 46 using the lifting member 22, the structures 12 that form the stack 46 and the one or more structures 12 to be added to the stack 46 can all be considered a set of structures. The one or more structures 12 to be added to the top 17 of the stack 46 can be considered to be positioned by the lifting member 22 in a first orientation 50a and the one or more structures 12 forming the layer 48 at the top 17 of the stack 46 may be considered to be in a second orientation 50b. When the lifting member 22 places the one or more structures 12 in the first orientation 50a on top of the layer 48 of the one or more structures 12 in the second orientation 50b, the one or more structures 12 in the first orientation 50a are connected to the one or more structures 12 in the second orientation 50b via the relevant connectors 38 and respective receptacles. Since the one or more structures in the second orientation 50b are also connected with the layer/s 48 below them, it follows that the entire set of structures would then be connected. This process of adding to the set of structures to connect the structures 12 and form the stack 46 is repeated when adding more structures 12 to the top 17 of the stack 46.

In this way, the structure 12 in the first orientation 50a as shown in FIG. 1 will act as a locking structure 12 when connected to the top layer 48 via the connectors 38 and receptacles, by not allowing the structures 12 in the top layer 48 of the stack 46 to move laterally as limited by the stiffness of the material of the locking structure 12, thereby connecting the structure/s 12 in the top layer 48 adjacently or side-by-side. The layers 48 below the top layer 48 being connected to the top layer 48 in an alternate configuration also inhibits the structures 12 of the top layer 48 from moving laterally, thereby strengthening the adjacent connection of the structures 12 in the top layer 48. The other layers 48 in the stack 46 are similarly connected which provides the releasable connectivity of the structures 12 in the stack 46. Further, in embodiments of the facility 10 where a plurality of stacks 46a, 46b are formed, the locking structure 12 may be placed and releasably connected to the top layers 48 of two or more of the plurality of stacks 46a, 46b, thereby connecting the two or more of the plurality of stacks 46a, 46b together. Connecting the two or more of the plurality of stacks 46a, 46b together may allow for the two or more of the plurality of stacks 46a, 46b to be considered a single stack 46. It will be understood that the two or more of the plurality of stacks 46a, 46b which are connected may include structures 12 of the same size, or may include structures 12 of varying sizes.

It will be understood that three, four, five, six, seven, eight, nine, 10, 11, 12, 13, 14, 15, 16, 17, 18, 19, 20, 30, 40, 50, 60, 70, 80, 90, 100, 1000, 10000, 100000, 1000000, or more stacks 46 may be formed in the facility 10, depending on the user demand placed on the facility 10 to retrieve the target structures 12b as discussed in more detail below.

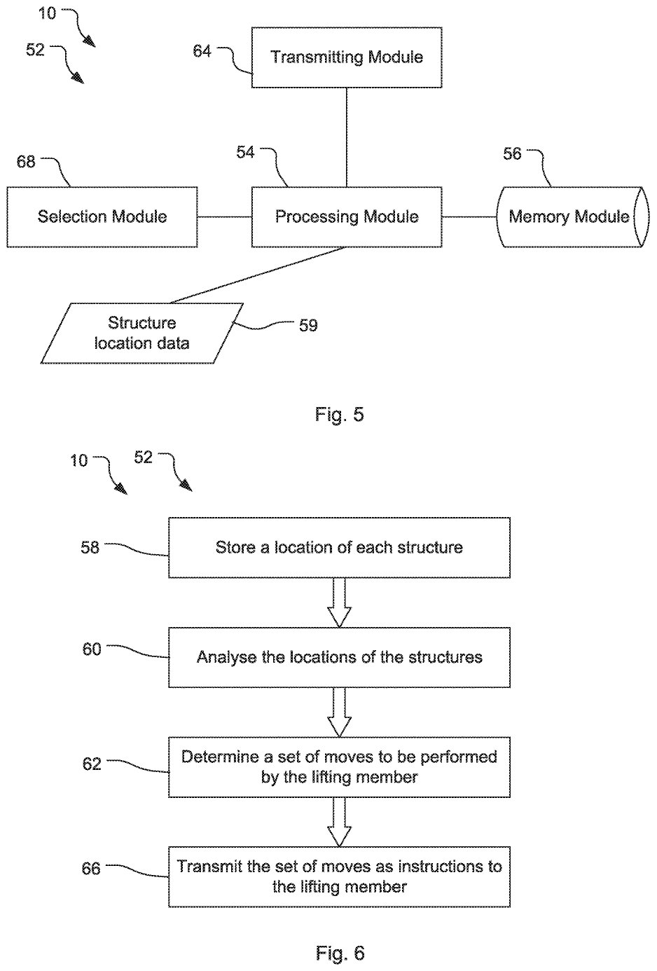

The storage facility 10 further comprises a controller 52 for operating the lifting member 22 of the crane 16. As shown in FIG. 4, the controller 52 comprises a processing module 54 configured to determine a set of moves for the lifting member 22 and a memory module 56 in communication with the processing module 54. As shown in FIG. 5, the processing module 54 is configured to: store 58 a location of each structure 12 in the stack 46 to the memory module 56, analyse 60 the locations of the structures 12 in the stack 46 to determine a set of structures 12a to be displaced for accessing the one or more target structures 12b, and determine 62 the set of moves to be performed by the lifting member 22. The sensors 40 of the frame 32 are in communication with the controller 52 to provide the structure location data 59 to the processing module 54 for storing in the memory module 56. It will be understood that the set of structures 12a may instead be a single structure 12, and that the set of moves may instead be a single move.

The controller 52 further comprises a transmitting module 64 in communication with the processing module 54 for transmitting instructions to the lifting member 22. The transmitting module 64 is configured to transmit 66 the set of moves as instructions to the lifting member 22 to perform the set of moves. Each move of the set of moves corresponds to one of the set of structures 12a being displaced, for example, one move may include the lifting member 22 disconnecting a structure 12a from the stack 46, displacing the structure 12a to a new position on the stack 46, and connecting the structure 12a to the new position on the stack 46.

In some embodiments, the set of structures 12a to be displaced is determined to allow the one or more target structures 12b to be positioned in a relatively accessible location, such as at the top 17 of the stack 46, in order for the lifting member 22 to easily attach to the one or more target structures 12b in order to disconnect the target structures 12b from the stack 46 and displace the target structures 12b for allowing access to the structures 12b by a user, for example, positioning the structures 12b on the base 26 or in water.

The controller 52 further comprises a selection module 68 in communication with the processing module 54 and is operable by a user to select one or more stored units 14a, 14b to be retrieved by the lifting member 22, each of the selected units 14a, 14b corresponding to a target structure 12b. The selection module 68 comprises a booking system for enabling a user to book a collection time for the one or more stored units 14a, 14b, and the transmitting module 64 is configured to transmit 66 the set of moves to the lifting member 22 at a predetermined time such that the selected units 14a, 14b are accessible by the user at the collection time. The selection module 68 communicates with the processing module 54 to prioritise and generate an order of the units 14a, 14b corresponding to target structures 12b to be retrieved by the lifting member 22, which affects the determination of the set of moves at the processing module 54 to be performed by the lifting member 22. The booking system may be configured to prioritise certain selected units 14a, 14b based on a user membership level, for example, a lower tier user membership level may require units 14a, 14b to be booked at least 7 days (or another period) in advance for retrieval, and a higher tier user membership level may require units 14a, 14b to be booked at least 3 days (or another period) in advance, indicating that the higher tier memberships have faster access to their units 14a, 14b. In another embodiment, users with a lower tier membership may be offered the opportunity to retrieve their units 14a, 14b faster in return for a one-off payment in addition to any membership fees. The booking system may further be configured to inform the user of the length of time that the facility 10 will require to retrieve the selected units 14a, 14b.

In some embodiments, the processing module 54 is configured to minimise a total number of moves in the set of moves. To achieve this, a model may be provided at the processing module 54 which interrelates a plurality of variables and the minimum set of moves. The model may be provided as a machine leaning model whereby the plurality of variables for inputting into the model may include one or more of the following: number and/or location of the target structure/s 12b in the stack 46 or stacks 46a, 46b, total number of the set of structures 12a, total number and/or size/s of the structures 12, frequency of user selection of the selected units 14a, 14b associated with the target structure/s 12b, the collection time selected by the user, user membership level, additional fees paid by the user, and number of spreaders 23, 25 carried by the lifting member 22.

Modules 64, 68 may be software applications stored in memory module 56, which, when executed, perform the actions outlined above. For example, modules 64, 68 could be functions or classes written in a programming language, such as C, C++ or Java. In some embodiments, modules 64, 68 are field programmable gate arrays (FPGAs) configured to execute the actions outlined above.

Memory module 56 could be any suitable form of memory. For example, memory module 56 may be volatile memory, such as cache or RAM, or non-volatile memory, such as an optical disk drive, hard disk drive, storage server, cloud storage, or any combination of these.

Processing module 54 may be hardware processor, such as a microcontroller or microprocessor, capable of receiving data and executing software applications to process the data. Processing module 54 may be a single processor or multiple processors. For example, processing module 54 may be a cloud based processing unit configured to carry out the actions outlined above.

FIG. 6 shows an embodiment of a unit storage method 100. The method 100 comprises storing 102 a unit 14a, 14b in each of the plurality of displaceable and releasably connectable structures 12, whereby each structure 12 is configured to support the unit 14a, 14b. The method 100 further comprises operating 104 the crane 16 to displace and releasably connect or disconnect one or more structures 12a of the plurality of structures 12.

Storing 102 the unit/s 14a, 14b in each of the structures 12 depends on the units 14a, 14b being stored. In the case of vessels 14a, the vessel 14a is loaded onto bearings, such as timber bearings, while in the water and the bearings may be lowered until the vessel 14a is floating at which point the structure 12 is floated toward the vessel 14a such that the vessel 14a is supported by the elongate supports 36 of the structure 12. The structure 12 carrying the unit 14a, 14b may then be transported to the facility 10 via a crane loading the structure 12 onto a vehicle, such as a truck, to be driven to the facility 10 or onto a conveyor destined for the facility 10.

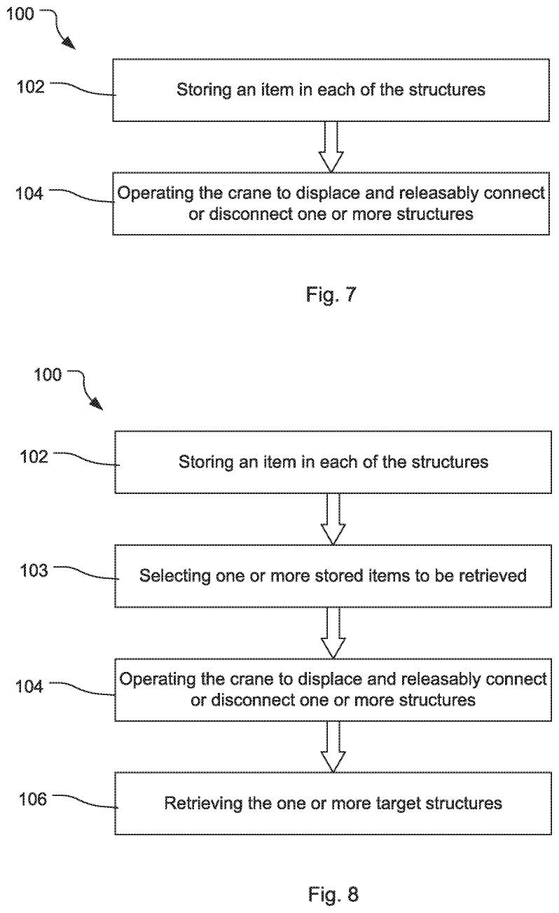

According to another embodiment of the method 100 shown in FIG. 7, operating 104 the crane 16 comprises retrieving 106 the one or more target structures 12b of the plurality of structures 12 (FIG. 7). The operating 104 of the crane 16 further comprises connecting the structures 12 to form the at least one stack 46, and the retrieving 106 the one or more target structures 12b comprises retrieving the one or more target structures 12b from the at least one stack 46. The operating the crane 16 further comprises arranging the layers 48 of the stack 46 in alternating orientations 50a, 50b. It will be understood that the method 100 is performed according to the processes and relevant features of the facility 10 described above.

The operating 104 the crane 16 further comprises using the controller 52 for operating the lifting member 22 of the crane 16, and performing the set of moves determined by the processing module 54 of the controller 52 using the lifting member 22, the set of moves being transmitted to the lifting member 22 via the transmitting module 64 of the controller 52. The performing the set of moves comprises displacing the set of structures 12a to allow the target structures 12b to be positioned at a desired location, for example the top 17 of the stack 46.

The method 100 further comprises selecting 103 one or more stored units 14a, 14b to be retrieved by the lifting member 22 using the selection module 68 of the controller 52, each of the selected units 14a, 14b corresponding to a target structure 12b.

In use, units 14a, 14b are stored 102 in each of the plurality of structures 12 of the facility 10 as described above. The user selects 103 one or more stored units 14a, 14b using the selection module 68 of the controller 52, the stored units 14a, 14b typically belonging to the user. The processing module 54 of the controller 52: stores 58 a location of each structure 12 in the stack 46 to the memory module 56, analyses 60 the locations of the structures 12 in the stack 46 to determine a set of structures 12a to be displaced for accessing the one or more target structures 12b, and determines 62 the set of moves to be performed by the lifting member 22. The transmitting module 64 of the controller 52 operates 104 the crane 16 by transmitting the set of moves to the lifting member 22 for the lifting member 22 to perform the set of moves to displace the set of structures 12a in order to position the target structure/s 12b at the top 17 of the stack 46. The target structures 12b are then retrieved 106 by the lifting member 22 and brought onto the base 26 for the selected unit/s 14a, 14b in the structures 12b to be accessed by the user, or the target structures 12b are lifted by the crane 16 directly into the water such that the vessel 14a is able to float and the target structure 12b is removed from the water and is therefore no longer considered a target structure 12b, since the user has successfully retrieved their unit 14a, 14b. It will be appreciated that the facility 10 may be provided proximate a port, dock or wharf to allow for convenient access and use of the user's vessel/s 14a.

Advantageously, the structures 12 obviate the need for a pathway to be provided in the facility 10 and therefore more space in the facility 10 can be dedicated to storing the units 14a, 14b. This provides a far more efficient use of space in the facility 10 compared to facility arrangements including a pathway. The crane 16 is also able to displace, connect and disconnect the structures 12 quickly and without facility personnel present amongst the structures 12 which may reduce the prevalence of injuries to the facility personnel from moving vehicles or falling items. Furthermore, the connectability of the structures 12 increases the structural integrity of the stack 46, compared to stacking the structures 12 and relying on a frictional engagement between the structures 12 to prevent the stack 46 from collapsing.

The structures 12 may be configured to accommodate either a vessel 14a or an automobile 14b in the same facility 10, which is convenient for the user to be able to retrieve their vessel 14a from the structure 12, then be able to park their automobile 14b in the structure 12 and the structure 12 be returned to the facility 10 while they use their vessel 14a. Their automobile 14b in the structure 12 may then be retrieved after the conclusion of the use of their vessel 14a and their vessel 14a may be returned to storage in the facility 10.

In addition, the user is conveniently able to select units 14a, 14b to be retrieved in advance using the booking system of the selection module 68, and the processing module 54 is configured to determine a minimum total number of moves of the set of moves to retrieve the selected units 14a, 14b, which may allow for more users to retrieve their units 14a, 14b more quickly.

It will be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data streams along a local network or a publicly accessible network such as the internet.

It will also be understood that, unless specifically stated otherwise as apparent from the above discussion, it is appreciated that throughout the description, discussions utilizing terms such as “estimating” or “processing” or “computing” or “calculating”, “optimizing” or “determining” or “displaying” or “minimising” or “maximising” or the like, refer to the action and processes of a computer system, or similar electronic computing device, that processes and transforms data represented as physical (electronic) quantities within the computer system's registers and memories into other data similarly represented as physical quantities within the computer system's memories or registers or other such information storage, transmission or display devices.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A unit storage facility, comprising:
a plurality of displaceable and releasably connectable structures, each structure being configured to support at least one unit and comprising a frame defining a first side and an opposed second side, a plurality of receptacles defined in the second side of the frame and a plurality of connectors disposed on the first side of the frame, a connector being receivable in a receptacle of another structure and configured to allow each structure to releasably connect with another structure and to allow the plurality of structures to be stacked in adjacent layers oriented in different directions to form at least one stack; and
a crane having a supporting structure and a crane body displaceably connected to the supporting structure, the crane body comprising a lifting member, the lifting member being operable to displace and releasably connect or disconnect one or more structures of the plurality of structures in the at least one stack.

2. The unit storage facility of claim 1, wherein the crane is operable to retrieve one or more target structures from the at least one stack.

3. The unit storage facility of claim 1, wherein the layers are arranged in alternating orientations.

4. The unit storage facility of claim 3, wherein each layer of the layers in the at least one stack is oriented at or approximately 90 degrees to an adjacent layer.

5. The unit storage facility of claim 1, wherein one or more of the plurality of structures has a different size to others of the plurality of structures.

6. The unit storage facility of claim 1, wherein the plurality of structures comprises one or more structures of a first, smaller size and one or more structures of a second, relatively larger size.

7. The unit storage facility of claim 6, wherein:
the structures of the first size are connected to form at least a first layer in the at least one stack, and the structures of the second size are connected to form at least a second layer in the at least one stack, or
the structures of the first size are connected to form a first stack, and the structures of the second size are connected to form a second stack.

8. (canceled)

9. The unit storage facility of claim 1, wherein each structure of the plurality of structures comprises one or more elongate supports fixed to the frame for supporting the stored at least one unit.

10. The unit storage facility of claim 9, wherein a set of structures are connectable by the lifting member placing one or more of the set of structures in a first orientation on top of a layer of one or more of the set of structures in a second orientation, such that one or more of the connectors of the, or each, structure in the second orientation are received in respective receptacles of the, or each, structure in the first orientation.

11. The unit storage facility of claim 2, comprising a controller for operating the lifting member of the crane, the controller comprising a processing module configured to determine a set of moves for the lifting member and a memory module in communication with the processing module, the processing module being configured to:
store a location of each structure in the stack to the memory module,
analyse the locations of the structures in the stack to determine a set of structures to be displaced for accessing the one or more target structures, and
determine the set of moves to be performed by the lifting member, each move corresponding to one of the set of structures being displaced.

12. The unit storage facility of claim 11, wherein each structure comprises at least one sensor in communication with the controller to provide structure location data to the processing module for storing in the memory module.

13. The unit storage facility of claim 11, wherein the set of structures to be displaced is determined to allow the one or more target structures to be positioned in a relatively accessible location.

14. The unit storage facility of claim 11, wherein the processing module is configured to minimise a total number of moves in the set of moves.

15. The unit storage facility of claim 11, wherein the controller further comprises a transmitting module in communication with the processing module for transmitting instructions to the lifting member.

16. The unit storage facility of claim 15, wherein the transmitting module is configured to transmit the set of moves as instructions to the lifting member to perform the set of moves.

17. The unit storage facility of claim 11, wherein the controller further comprises a selection module in communication with the processing module, the selection module being operable by a user to select one or more stored units to be retrieved by the lifting member, each of the selected units corresponding to a target structure.

18. The unit storage facility of claim 17, wherein the selection module comprises a booking system for enabling a user to book a collection time for the one or more stored units, the transmitting module being configured to transmit the set of moves to the lifting member at a predetermined time such that the selected units are accessible by the user at the collection time.

19. (canceled)

20. (canceled)

21. (canceled)

22. A unit storage method, comprising:
storing at least one unit in each of a plurality of displaceable and releasably connectable structures, each structure being configured to support the at least one unit and comprising a frame defining a first side and an opposed second side, a plurality of receptacles defined in the second side of the frame and a plurality of connectors disposed on the first side of the frame, a connector being receivable in a receptacle of another structure and configured to allow each structure to releasably connect with another structure and to allow the plurality of structures to be stacked in adjacent layers oriented in different directions to form at least one stack; and
operating a crane to displace and releasably connect or disconnect one or more structures of the plurality of structures in the at least one stack, the crane having a supporting structure and a crane body displaceably connected to the supporting structure, the crane body comprising a lifting member, the lifting member being operable to displace and releasably connect or disconnect the one or more structures of the plurality of structures in the at least one stack.

23. The unit storage method of claim 22, wherein the operating the crane comprises:
retrieving one or more target structures of the plurality of structures; or
connecting the structures to form the at least one stack, and wherein the retrieving the one or more target structures comprises retrieving the one or more target structures from the at least one stack.

24-26. (canceled)

27. The unit storage method of claim 22, wherein operating the crane further comprises using a controller for operating the lifting member of the crane, the controller comprising a processing module configured to determine a set of moves for the lifting member and a memory module in communication with the processing module, the processing module being configured to:
store a location of each structure in the stack to the memory module,
analyse the locations of the structures in the stack to determine a set of structures to be displaced for accessing the one or more target structures, and
determine the set of moves to be performed by the lifting member, each move corresponding to one of the set of structures being displaced.

28-30. (canceled)
